(19) United States
(12) Patent Application Publication
(10) Pub. No.: US 2020/0307559 A1
(43) Pub. Date: Oct. 1, 2020

(54) AUTOMATIC REPOSITIONING OF A PARKED VEHICLE

(71) Applicant: Volkswagen Aktiengesellschaft, Wolftsburg (DE)

(72) Inventors: Bastian Göricke, Wolfsburg (DE); Philipp Hüger, Ruhen (DE)

(21) Appl. No.: 16/831,561

(22) Filed: Mar. 26, 2020

(30) Foreign Application Priority Data
Mar. 27, 2019 (DE) 10 2019 204 203.1

(51) Int. Cl. B60W 30/06; B60W 50/14; B60W 10/20

(52) U.S. Cl. CPC B60W 30/06; B60W 2554/406; B60W 10/20; B60W 50/14

(57) ABSTRACT

The disclosed invention relates to a system and method for autonomously repositioning a vehicle from a temporary parking position to a final parking position. The vehicle can be manually driven to the temporary parking position by a driver, who may then exit the vehicle. The vehicle, using an electronic parking assistance system, can then determine whether to reposition the vehicle based on whether one or more decision criteria are triggered. If the electronic parking assistance system determines that the vehicle must be repositioned, then the vehicle is autonomously moved from the temporary parking position to the final parking position by the electronic parking assistance system.

### CROSS-REFERENCE TO RELATED APPLICATION(S)

This patent application claims priority to German patent application DE 10 2019 204 203.1, which was filed on Mar. 27, 2019, the entire disclosure of which is hereby incorporated by reference.

### BACKGROUND

Typically, motor vehicles, such as automobiles and trucks, can be parked in a marked parking zone by the vehicle operator or driver. In such cases, the vehicle operator manually performs the necessary movements of the motor vehicle by actuating the steering wheel and braking or accelerating the vehicle to maneuver the vehicle into the parking zone.

With the introduction of autonomous and semi-autonomous vehicles, electronic parking assistance systems are now available in motor vehicles. The electronic parking assistance systems can maneuver the motor vehicle into the parking zone with little or no assistance from the vehicle operator, who may or may not be located inside the vehicle at the time of the parking process.

In the case where the electronic parking assistance system is controlled externally by the vehicle operator when performing the parking process, current systems still require the vehicle operator to remain in the vicinity of the motor vehicle and control or monitor the parking process. This causes the vehicle operator to wait near the motor vehicle even after exiting the vehicle to allow the parking process to complete. Further, the time required to perform the fully autonomous or partially autonomous parking process can be long. At locations with heavy traffic flow, other motor vehicles may need to slow down or stop to allow the autonomous or partially autonomous parking process to complete. This may cause traffic disruptions, delays, and irritate other motor vehicle operators.

### SUMMARY

In general terms, this patent document is directed to a system and method for autonomously repositioning a vehicle from a first parking position to a second parking position. The first parking position can be a temporary parking position, and the second parking position can be a final parking position.

### BRIEF DESCRIPTION OF THE DRAWINGS

FIG. 1 is a block diagram illustrating aspects of an example of a vehicle having a controller for autonomous positioning of the vehicle for parking.

FIG. 2 schematically illustrates an example of a computing system shown in FIG. 1.

FIG. 3 is a flow diagram illustrating an example of operations executed when autonomously positioning the vehicle shown in FIG. 1.

FIGS. 4a-4c illustrate an example of autonomously positioning the vehicle shown in FIG. 1.

FIGS. 5a-5d illustrate another example of autonomously positioning the vehicle shown in FIG. 1.

### DETAILED DESCRIPTION

Various embodiments are described in detail with reference to the drawings. Reference to the drawings and the various embodiments in this written specification does not limit the scope of the claims attached hereto. Additionally, the examples set forth in this written description are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. Use of the term “a” means “one or more” unless stated otherwise or where the use of “one or more” is clearly inappropriate. Use of the term “comprise,” “comprises,” “comprising,” “include,” “includes,” including,” “having,” and “has” are interchangeable and are not intended to be limiting. For example, the term “including” shall mean “including, but not limited to.” The term “such as” also is not intended to be limiting.

Terms such as “substantially” or “about” when used with values or structural elements provide a tolerance that is ordinarily found during testing and production due to variations and inexact tolerances in factors such as materials and equipment. These terms also provide a tolerance for variations due to environmental conditions such as temperature and humidity. Such variations also can be due to normal wear and tear over the life of apparatuses that embody the appended claims.

In general terms, this patent document is directed to parking a vehicle in a parking zone, in which the vehicle is driven on a path outside the parking zone into a first parking position. The first parking position may be in the parking zone. The vehicle is then autonomously repositioned from the first parking position to a second parking position within a parking zone. The parking zone typically is a parking spot that has boundaries of some type, such as painted stripes, a marker, or a structure such as a curb or tire stop. For example, the vehicle may be driven to the parking zone with a user, such as a driver or vehicle occupant present in the vehicle, and then parked in a temporary parking position within a parking zone. After reaching the temporary parking position of the vehicle, the user(s) exits the vehicle. On the basis of at least one decision criterion, an autonomous parking process then may reposition the vehicle from the temporary parking position to a final parking position that differs from the temporary parking position. In various embodiments, the autonomous process of repositioning the vehicle can be performed with the users in the vehicle or after the users (including the driver) exit the vehicle.

The disclosed system and method of autonomously repositioning the vehicle from a first parking position to a second parking position is typically more efficient than manually parking the vehicle into a final position. Because parking the vehicle into the temporary position can be done quickly and immediately, the autonomous process disclosed herein can reduce delays experienced by pedestrians and other vehicles as the driver tries to manually maneuver the vehicle back and forth to park in a suitable position.

Another advantage of the disclosed system and method includes time savings for the vehicle user (e.g., driver or occupant) because the disclosed parking process does not require the user to be present while the autonomous process of repositioning the vehicle is performed. After reaching the first parking position and before the autonomous parking process is performed, the user can leave the vicinity of the vehicle and attend to actual interests instead of supervising or monitoring the parking process itself.

In another example, a vehicle control system, which is described in more detail herein, may determine that the first parking position meets or exceeds criteria defining a suitable parking position. In this situation, the vehicle control system may determine that the vehicle does not need to be repositioned and takes no action to autonomously reposition the vehicle from the first parking position.

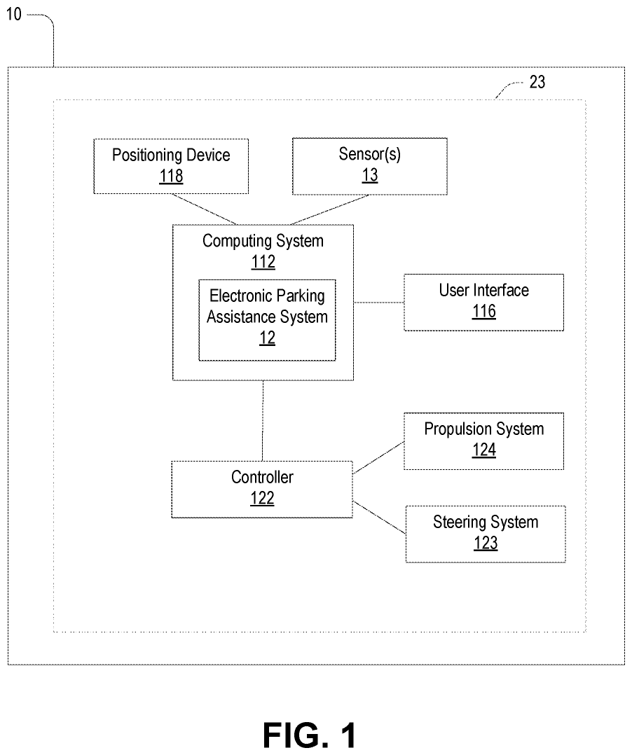

Referring to FIG. 1, a vehicle 10 has a control unit 23 for automatically repositioning the vehicle 10 from a first parking position to a second parking position. In at least some example embodiments, the first parking position can be a temporary or initial parking position, and the second parking position can be a final position. Additionally, the vehicle 10 can be an autonomous vehicle that drives itself, a non-autonomous vehicle that is manually operated by a driver, or a semi-autonomous vehicle that has driver assist features in addition to the autonomous repositioning system disclosed herein.

In at least some example embodiments, the vehicle 10 includes a computing system 112 having a processor and a memory in data communication with the processor. The computing system 112 is in data communication with peripheral devices, such as a user interface 116, a positioning device 118, sensors 13, and a controller 122. The computing system 112 is programmed with an electronic parking assistance system 12.

One or more user interfaces 116 are configured to receive information and control signals input by a user. An example of a user interface 116 is a button on the vehicle's key fob that the user can push to manually initiate the autonomous process for repositioning the vehicle 10 from a first parking position to a second parking position. Another example is a graphical user interface on a smartphone, tablet, or other computing device. In various embodiments, the graphical user interface has a control, such as a virtual button, the user can actuate to initiate the autonomous process of repositioning the vehicle 10. The graphical user interface also can include other types of virtual controls such as a keyboard, dials, switches, or other indicia, for entering user preferences, which are user-defined criterion or parameters regarding the user's preferences related to the second parking position or related to other features of the autonomous parking process disclosed herein. An example of user-defined criterion that governs the process for autonomously repositioning the vehicle's parking position includes criterion or parameters that control whether the vehicle 10 should be parked forward in the parking zone so it is forward or front facing or backed into the parking zone so it is backwards or rear facing. Other examples of user interfaces include keyboards, touch screens displaying graphical user interfaces, pointing devices, push buttons, and switches. The user interface 116 also can be implemented on a separate computing device that is in data communication with the computing system 112 directly through a data cable, directly through a wireless connection, or remotely through a network connection such as the Internet or an Intranet. Examples of separate computing devices that can be connected to the computing system 112 include desktop computers, laptop computers, tablet devices, and smartphones.

The positioning device 118 includes devices such as global positioning systems (GPS) and maps that can be used to determine the vehicle's geographic position. Depending on the information included in the mapping software, the positioning device 118 can determine the position of the vehicle 10 relative certain features that may be relative to parking the vehicle 10, such as pedestrian pathways, entryways to buildings, and drive lanes in parking lots. As discussed in more detail herein, this information in turn can be used to help the vehicle 10 navigate, determine distances traveled, and even determine the vehicle's position or longitudinal orientation within a parking lot.

The sensors 13 detect environmental features in the environment surrounding the vehicle 10. Examples of environmental features include painted strips and other markers defining the boundaries of parking zones; drive lanes; obstacles such as tires stops, curbs, light poles, landscaping, oncoming traffic, pedestrians, and other parked vehicles; and other features such as puddles and snowpack. The computing system 112 and the electronic parking assistance system 12 can use this information about environmental features for various operations such as determining the position of the vehicle 10 relative to one or more parking zones, drive lanes, surrounding structures, the location or depth of puddles or snow, the distance and rate of travel for approaching pedestrians and oncoming traffic, the width of the parking zone, the width of drive lanes, or other dimensions relative to the process of maneuvering and parking the vehicle 10.

Examples of sensors 13 include radar antennas and electronics; ultrasound transducers and associated electronics; imaging sensors and associated electronics such as charge-coupled devices, cameras, and optical recording units; LIDAR and other types of laser scanners; piezo-electric transducers; encoders such as rotary encoders; accelerometers; compasses; and clocks. Signals from the sensors 13 are input to the computing system 112, which can process the signals and record the related information. The computing system 112 can use the output from a single sensor 13 or the outputs from two or more sensors 13 when automatically repositioning the vehicle 10 from a first position to a second position. When using the outputs from two or more sensors 13, the computing system 112 can more accurately evaluate detected information, such as the location and speed of surrounding objects. As a result, the computing system 112 can get more comprehensive and precise information about the environment surrounding the vehicle 10 and make more accurate assessments of the vehicle's position and autonomous movements during the autonomous repositioning process. Additionally, different sensors 13 can perform better in different environmental conditions so receiving input from multiple sensors 13 can provide a more consistent performance of the autonomous repositioning process.

The vehicle controller 122 is in data communication with the computing system 112 and receives data and instructions from the computing system 112 related to aspects of driving a vehicle 10 including the speed and trajectory that the vehicle 10 should take during operation. In turn, the vehicle controller 122 operates components in the steering system 123 and the propulsion system 124 during the autonomous process of repositioning the vehicle 10. Examples of components in the propulsion system 124 include electric motors for driving the wheels if the vehicle 10 is an electric or hybrid vehicle, the transmission, and the engine if the vehicle 10 is driven by a gasoline or diesel engine. Components in the steering system 123 include the steering gear and any motor or hydraulics of operating the steering gear.

The controller 122 also can actuate and control any audible or visual warnings that are actuated during the autonomous process of repositioning the vehicle 10. Alternatively, such audible or visual warnings are controlled by the electronic parking assistance system 12 through the input/output unit 206.

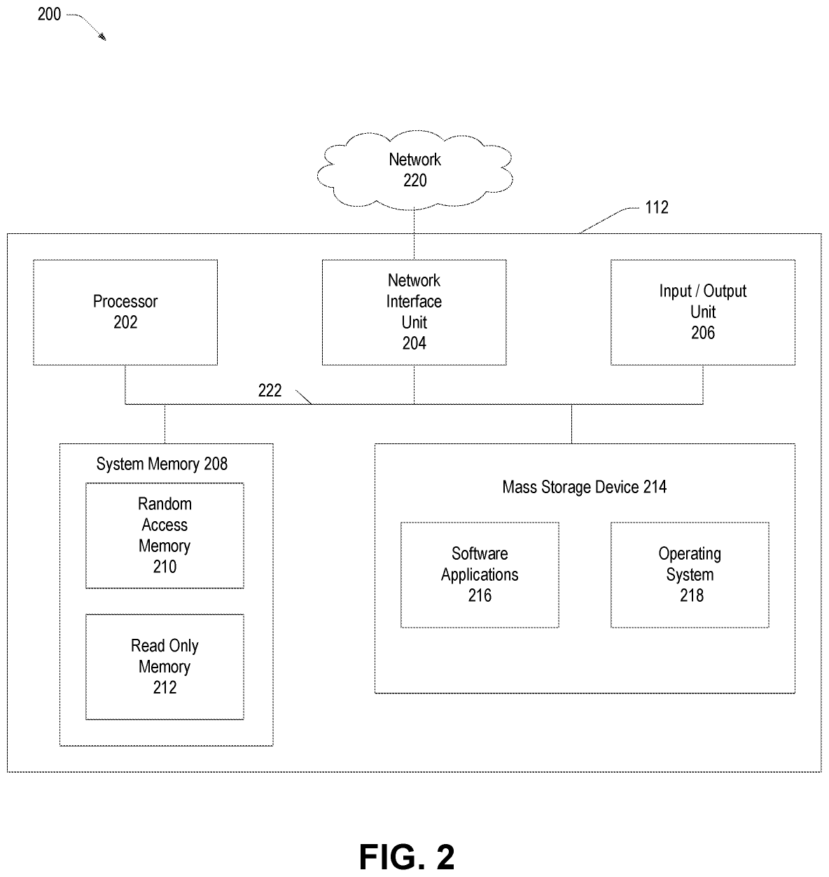

As illustrated in FIG. 2, the computing system 112 includes a processor 202, network interface unit 204, input/output unit 206, system memory 208, mass storage device 214, and one or more data buses 222. The processor 202 can be any circuit that processes information and can include any suitable digital or analog circuit. The processor 202 also can include a programmable circuit that executes instructions. Examples of programmable circuits include central processing units (CPU), microprocessors, microcontrollers, application specific integrated circuits (ASICs), programmable gate arrays, field programmable gate arrays, or any other processor or hardware suitable for executing instructions. The processor 202 can comprise a single unit or a combination of two or more units (which can be located in the same location or different locations). Additionally, the computing system 112 and individual processors 202 can execute instructions for systems and vehicle features in addition to the autonomous system for autonomously repositioning a vehicle 10 from a first parking position to a second parking position.

The system memory 208 and mass storage memory 214 include non-volatile, non-transitory program memory storing executable instructions, data structures, drivers, routines, program modules, vehicle or user specific data such as user preferences for execution of the autonomous system for repositioning the vehicle 10 from the first parking position to the second parking position, and any other executable code or data. Examples of system memory 208 include random access memory (RAM) 210, read only memory (ROM) 212, erasable programmable read only memory (EPROM), electrically erasable programmable read only memory (EEPROM), flash memory or other solid state memory devices, magnetic memory such as tapes or rotating magnetic discs, optical memory such as compact disks (CD-ROM) or digital versatile discs (DVD), or another suitable memory technology. The system memory 208 can be used to store all types of data including data for execution or use by the processor 202 as well as volatile data memory for temporary data storage while program instructions are executed.

Examples of mass storage devices 214 include hard disks and other magnetic storage media, solid-state storage devices, optical drives, and flash drives. The mass storage device 214 stores executable instructions and data for software applications 216 and an operating system 218 suitable for controlling the operation of the computing system 112. The mass storage device 214 also can be used to store vehicle or user specific data such as maps, determination criterion for execution of the autonomous system for repositioning the vehicle 10 from the first position to the second position, and user preferences.

The input/output unit 206 provides data communication between the processor 202 and components such as the sensors 13, positioning device 118, user interfaces 116, and controller 122. The input/output unit 206 also can have data ports for connecting remote computing devices to the computing system 112. In at least some example embodiments, data connections through the input/output unit 206 can be wired or wireless. The network interface 204 provides an interface between the computing system 112 and a data network, such as the Internet or an Intranet. In at least some example embodiments, the network interface unit 204 can provide a wireless connection or a wired connection.

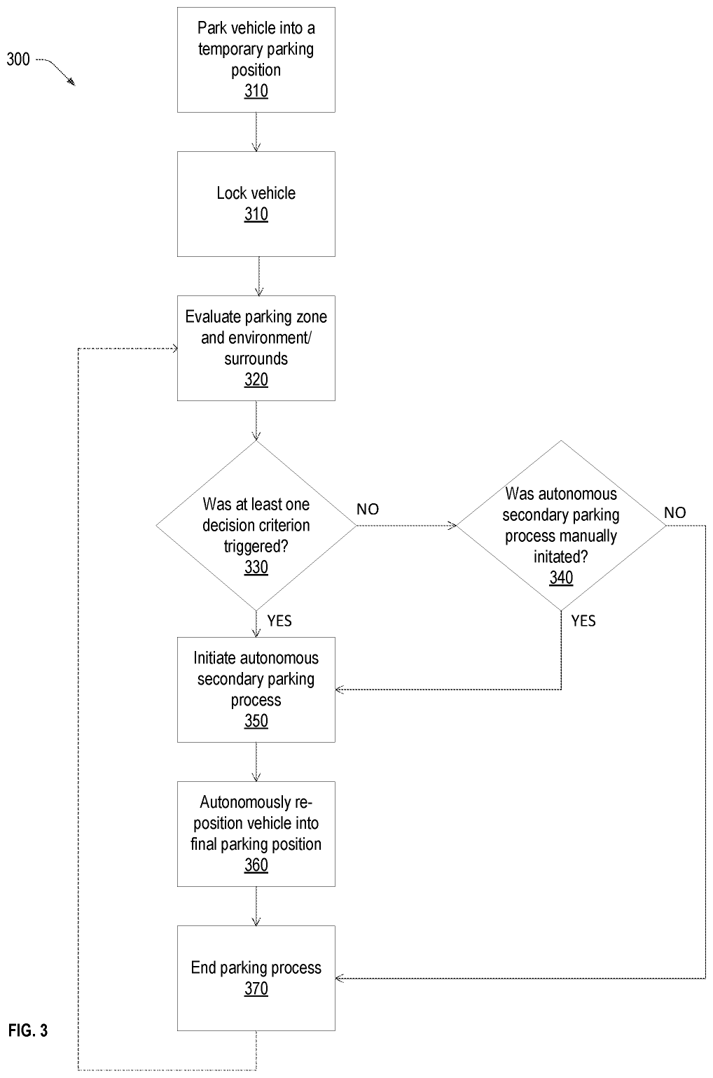

FIG. 3 is a flow diagram illustrating an example execution of a system for autonomously repositioning a vehicle 10 from a first position to a second position. In at least some example embodiments, the first position can be a temporary position, and the second position can be a permanent or non-temporary position.

In operation 310, a driver or vehicle operator of the vehicle 10 performs the primary parking process, which includes manually parking the vehicle 10 in a first parking position, which is a temporary position. In other example embodiments, the vehicle 10 is an autonomous vehicle and is autonomously driven into the first parking position. The first position may be in a parking zone, across two or more adjacent parking zones, or in a drive lane. In at least some example embodiments, the primary parking process is performed quickly so there is minimal or no interference with traffic flow. During the primary parking process, the vehicle 10 is typically parked in such a way that the driver or the vehicle occupant can readily exit the vehicle 10.

In at least some embodiments, the vehicle 10 is parked in the temporary parking position with a single driving maneuver from outside the parking zone. As a result, this primary parking process is performed particularly quickly because multiple maneuvers, especially backing up, are not necessary. As a result, the traffic flow taking place in the vicinity of the parking zone is minimally impeded. The focus on speed during the primary parking process gives the user (e.g., driver and other occupants) the option to quickly vacate the vehicle 10 so that the users do not experience any significant loss of time and can quickly carry out planned activities after parking.

In at least some embodiments, the vehicle 10 is locked automatically in operation 315 after the users exit the vehicle 10 and move outside of a reference zone. The reference zone can be defined by a determined radius extending from a point on the vehicle 10. The locking process provides a level of security, particularly in cases where the user vacates the vehicle 10 and immediately leaves the reference zone surrounding the vehicle 10. In at least some example embodiments, the vehicle 10 determines whether the user is in the reference zone by processing a signal from the key fob or other electronic device that is carried by the user. The driver is presumably carrying the key fob, although it could be carried by a non-driving occupant of the vehicle 10. The vehicle 10 receives a signal from the key fob and measures the signal strength to determine the distance of the key fob, which typically corresponds to the distance of the user from the vehicle 10. In other example embodiments, the vehicle 10 has two or more receivers that receive a signal from the key fob and triangulates the signal to determine the distance of the key fob from the vehicle 10. In various embodiments, the automatic locking mechanism also can take place regardless of whether the vehicle 10 is: (i) in the first parking position; (ii) in an intermediate stopping position that occurs during the autonomous repositioning processes; (iii) while the vehicle 10 is moving along a path from the first parking position to the second parking position; or (iv) already in the second position.

In other embodiments, the user can manually lock the vehicle 10. For example, if the driver exits the vehicle 10, but is still in the reference zone surrounding the vehicle 10, the driver may want to manually lock or unlock the vehicle 10. For example, the driver may want to unlock the vehicle 10 if the driver or someone else needs to access the interior of the vehicle 10 again. Alternatively, the user may want to lock the vehicle 10 before leaving the reference zone to keep someone else from entering or reentering the vehicle 10. However, in some embodiments, even when the user has manual control to initiate the locking mechanism, the automatic locking mechanism can still be actuated when the user has moved outside the reference zone or some other condition is met. Automatically locking the vehicle 10 when the user is outside the reference zone ensures that the vehicle 10 does not stay unlocked if he or she forgets to manually lock the vehicle 10 upon vacating the vehicle 10. Similarly, the vehicle 10 can be automatically unlocked with the key fob as the key fob moves from a position outside of the reference zone to a position inside the reference zone. In at least some embodiments, the process of autonomously repositioning the vehicle 10 can be automatically started when the driver exits the reference zone or when the driver manually locks the vehicle 10 using a remote device such as the key fob. In yet other embodiments, the autonomous process of repositioning the vehicle 10 is performed regardless of whether the vehicle 10 is locked.

In operation 320, the electronic parking assistance system 12 evaluates the environment surrounding the vehicle 10. The electronic parking assistance system 12 may use information corresponding to the output of one or more sensors 13, the positioning device 118, or any other suitable device and method to evaluate and assess the current position of the vehicle 10 and the environment surrounding the vehicle 10. For example, the electronic parking assistance system 12 can use image recognition technology to recognize or detect painted lines, other visual markers indicating the boundaries of a parking zone or drive lane, obstacles, or other things in the surrounding environment. The electronic parking assistance system 12 also can use image recognition technology to determine the orientation of the vehicle 10 and the position of other environmental features surrounding the vehicle 10. For example, the electronic parking assistance system 12 could use image recognition technology to determine the longitudinal orientation of the vehicle 10 (e.g., whether the vehicle is forward facing or rear facing). In another example, the longitudinal orientation can be determined using a combination of image recognition and outputs from accelerometers, a compass, or the positioning device 118 (e.g., GPS and mapping software).

In at least some embodiments, the electronic parking assistance system 12 evaluates the current position (the temporary parking position) of the vehicle 10 in relation to things in the vehicle's surrounding environment including the current parking zone, other parking zones near the current parking zone, and the drive lane leading through the parking lot. The electronic parking assistance system 12 also evaluates the current position of the vehicle 10. For example, the vehicle 10 may have a temporary parking position that is already in the only unoccupied parking zone in the near vicinity. In another example, the vehicle 10 may have a temporary parking position in a parking zone that is directly across, adjacent or adjoining to an unoccupied parking zone. If the electronic parking assistance system 12 determines there is open or unobstructed space in a drive lane or adjacent parking zone, it may temporarily maneuver the vehicle 10 into the open space during the autonomous process of repositioning the vehicle 10. In other example embodiments, the electronic parking assistance system 12 also may determine that a nearby parking zone is better suited for the vehicle 10 than the current parking zone and maneuver the vehicle 10 to the nearby parking zone during the autonomous repositioning process.

In operation 330, the electronic parking assistance system 12 uses the data from its evaluation in operation 320 to decide whether at least one decision criterion was triggered. If a decision criterion was triggered, the electronic parking assistance system 12 will initiate the autonomous repositioning system, operation 350, and cause the vehicle 10 to autonomously reposition from the first parking position to the second parking position.

In at least some example embodiments, a decision criterion is a preset criterion programmed by the manufacturer or service technician that defines a particular condition related to the vehicle 10, the parking zone, or the area surrounding the parking zone. In at least some embodiments, the decision criterion includes trained criterion that the electronic parking assistance system 12 can learn through artificial intelligence or other machine learning algorithms. In at least some example embodiments, the decision criterion can include user-defined criterion or parameters that are entered or programmed into the control system 23 by the user.

If the decision criterion is met, the electronic parking assistance system 12 may perform the autonomous repositioning process and reposition the vehicle 10 from the first parking position to the second parking position, the first parking position being different than the second parking position. Examples of decision criterion include the orientation of the vehicle 10 relative to the parking zone, the position of the vehicle 10 relative to the boundaries of the parking zone or relative to some other aspect of the current parking zone, the position of the vehicle 10 relative to proximal parking zones, the occupancy state of parking zones proximal to the vehicle 10, the position of the vehicle 10 relative to a drive lane proximal to the parking zone, the position of the vehicle 10 relative to any pedestrian paths proximal to the parking zone, the position of obstacles or other structures proximal to the vehicle 10, and other environmental features. Other factors that can be used to determine whether to perform the autonomous repositioning process includes the amount of time or number of maneuvers it would take to reposition the vehicle 10.

In at least some example embodiments, the electronic parking assistance system 12 determines that none of the decision criterion are met or otherwise triggered when the vehicle 10 is in the first or temporary parking position. In this situation, the electronic parking assistance system 12 may determine that the first parking position is a suitable parking position and that the vehicle 10 does not need to be repositioned to a second parking position. For example, the electronic parking assistance system 12 may determine to not reposition the vehicle 10 from the first or initial parking position if the parked vehicle 10 is properly oriented in the parking zone and is adequately spaced from surrounding objects and the painted stripes that define the boundaries of the parking zone. If the electronic parking assistance system 12 determines that no decision criteria are met or that the vehicle 10 does not otherwise need to be repositioned, the first parking position is the same as the second or final parking position and the vehicle 10 is not repositioned.

There are many examples of circumstances in which the electronic parking assistance system 12 may determine that the first parking position of the vehicle 10 is unsuitable or otherwise improper and thus autonomously controls the vehicle 10 to move from the first parking position to the second parking position. For example, an unsuitable parking position can be a position that violates or otherwise is not in compliance with parking regulations. In other examples, an unsuitable parking position can be a position in which the centerline or longitudinal axis of the vehicle 10 is at an angle to, or offset from, the centerline or longitudinal axis of the parking zone. For example, the vehicle 10 might be too close to the boundary between two adjacent parking zones. In at least some example embodiments, the electronic parking assistance system 12 may determine that the current parking position is unsuitable if the angle between the longitudinal axis of the parking zone and the longitudinal axis of the vehicle 10 is greater than a determined amount, or the offset between the longitudinal axes is greater than a determined amount.

Similarly, the vehicle 10 could protrude into a parking zone adjacent to the vehicle's current parking zone or protrude into the drive lane of the parking lot. Such parking positions could result in one or more adjacent parking zones that are no longer usable by other vehicles, obstruct the opening of doors in other vehicles that are parked in adjacent parking zones, or present an obstruction to traffic or pedestrians in the drive lane. Because such parking positions are disadvantageous for road users using adjacent parking zones, the vehicle 10 may be autonomously repositioned from the first, current parking position to a second parking position.

The examples of unsuitable parking positions disclosed in this patent document are not uncommon in actual practice. Additionally, there are many other examples of unsuitable parking positions that can be corrected using the disclosed process of autonomously repositioning the vehicle 10 from a first parking position to a second parking position.

As discussed herein, user-defined criterion also can be used in the autonomous process of repositioning the vehicle 10. An example of a user-defined criterion is a preference for a determined parking orientation. For example, the user could set a user-defined criterion to park facing forward in the parking zone, or facing backwards in the parking zone. A preferred orientation of the vehicle 10 can be set in the control system 23 and then can serve as a decision criteria. If the vehicle 10 is initially parked forward facing in the parking zone but the user set a preference for parking backwards, the electronic parking assistance system 12 may autonomously reposition the vehicle 10 even if the electronic parking assistance system 12 does not otherwise determine the first parking position to be unsuitable. In this scenario, the vehicle 10 would autonomously move out of the parking zone and then back into the parking zone so that it is facing backward according to the user-defined criterion.

Having control over the orientation of the parked vehicle 10 may provide several advantages to the driver. For example, a particular orientation of the vehicle 10 may provide an advantageous position for the driver. A parking orientation in which the vehicle 10 is parked backwards and is rear facing provides the driver with a better field of view when exiting the parking zone because they can directly see the drive lane, which can reduce the risk of striking a car, pedestrian, or some other obstruction when exiting the parking zone. With this user-defined criterion, the driver can quickly drive the vehicle 10 forward into the parking zone so it is front facing when in the first parking position. After the driver exits the vehicle 10, the electronic parking assistance system 12 then pulls the vehicle 10 out of the first parking position in the parking zone and backs the vehicle 10 into a second position within the parking zone so it is rear facing. In another example, the driver may prefer the vehicle 10 to be parked forward facing in the parking zone because he or she likes to have easy access to the trunk or tailgate. In this situation, the vehicle 10 is parked forward facing when in the second parking position.

In at least some example embodiments, the electronic parking assistance system 12 is programmed to automatically initiate the process of autonomously repositioning the vehicle 10 if decision criterion is met. In other example embodiments, the electronic parking assistance system 12 does not automatically initiate the autonomous repositioning process and executes the process only upon receiving a manual command from the user. This embodiment gives the user the option to decide whether the first parking position is good enough that the autonomous reposition process does not need to be performed. In other example embodiments, the vehicle 10 does not provide the user with the option to manually initiate the process of autonomous repositioning of the vehicle 10.

In operation 340, if the electronic parking assistance system 12 does not automatically initiate the process of autonomously repositioning the parked vehicle 10, at least some example embodiments of the system will determine whether a user manually requested repositioning of the vehicle's parking position. For example, the electronic parking assistance system 12 could set a user-defined criterion that controls the electronic parking assistance system 12 to autonomously reposition the vehicle 10 only upon being manually controlled by the user. In other example embodiments, the electronic parking assistance system 12 can be programmed to autonomously reposition the vehicle 10 if preprogrammed decision criterion are met, but then use the user-defined criterion in the autonomous repositioning process only if the user manually activates the user-defined criterion. In these example embodiments, the driver has the flexibility to decide whether to autonomously reposition the vehicle 10 or to use user-defined parameters. An advantage of these embodiments is that the user can have as much time as they need to collect objects from their vehicle 10, or he or she may determine that it is not necessary to reposition the vehicle 10.

In at least some example embodiments, the user can manually initiate the autonomous process of repositioning the vehicle 10 through the user interface 116. In some embodiments, the key fob may have a button dedicated to the autonomous repositioning process. The user simply presses this button when they want to initiate the process. In other possible embodiments, the process is initiated when the user presses the lock button on the key fob.

In operation 350, the autonomous process of repositioning the vehicle 10 is initiated, and then in operation 360 the vehicle 10 is autonomously repositioned from the first position to the second position. In at least some embodiments, the autonomous process of repositioning the vehicle 10 begins immediately upon a determination that at least one decision criterion is met or triggered. In at least some alternative embodiments, the start of the autonomous process for repositioning the vehicle 10 is delayed. For example, a time period for the delay may begin upon parking the vehicle 10 or upon the user exiting the vehicle 10. In other alternative embodiments, the autonomous process begins after the control system 23 determines that the user is a determined distance from the vehicle 10. An advantage of delaying the start of the autonomous repositioning process is that the user will have time to exit the vehicle 10 and gather their things from the vehicle 10 before it begins to move. Another advantage is the user can leave the vicinity of the vehicle 10 immediately after exiting it without having to attend, observe, or monitor the autonomous process of repositioning of the vehicle 10, which can enable the user to get to his or her final destination quicker and thus save time.

In at least some embodiments, the start of the autonomous process of repositioning the vehicle 10 from the first position to the second position depends on current traffic conditions in the area proximal to or surrounding the vehicle 10. The start of the autonomous repositioning system also may depend on traffic that is expected to develop in the future. Delaying the autonomous process of repositioning the vehicle 10 based on traffic conditions may reduce interference to the flow of traffic around the vehicle 10. In these embodiments, a delay in the start of the autonomous repositioning process can be observed until it is determined that there is little or no traffic proximal to the vehicle 10.

In operation 360, the electronic parking assistance system 12 autonomously repositions the vehicle 10 from a first parking position to a second parking position, the first parking position being different than the second parking position. In some embodiments, the electronic parking assistance system 12 determines one or more intermediate stopping positions into which to temporarily position the vehicle 10 as it moves from the first parking position to the second parking position. The electronic parking assistance system 12 also determines a path along which to move the vehicle 10. After determining the intermediate stopping positions and the paths for moving the vehicle 10, the electronic parking assistance system 12 causes the vehicle 10 to autonomously move from the first parking position to the second parking position via the determined intermediate stopping positions and the determined paths. In various example embodiments, the intermediate stopping positions can be on the determined path or adjacent to the determined path. In at least some example embodiments, an intermediate stopping position is a position in which the vehicle 10 might stop to reverse direction or otherwise change its trajectory.

The electronic parking assistance system 12 determines the intermediate stopping positions and the paths of movement based on features of the environment detected in operation 320 during evaluation of the parking zone and surrounding environment. In at least some embodiments, the electronic parking assistance system 12 determines the intermediate stopping positions and vehicle path before the vehicle 10 moves from the first position during the autonomous process of repositioning the vehicle 10. Determining the intermediate stopping positions and the vehicle path before moving the vehicle 10 from the first parking position can enable the vehicle 10 to be positioned quickly and with minimal disruption to nearby traffic. In at least some embodiments, the electronic parking assistance system 12 can delay the start of the autonomous repositioning process if the traffic in the drive lane or other areas based on traffic in the area surrounding the vehicle 10, for example, the traffic may be too busy to safely move the vehicle 10 from the first parking position to the drive lane.

In at least some possible embodiments, the electronic parking assistance system 12 determines the intermediate stopping position and the vehicle path after the vehicle 10 begins to move from the first parking position. In these embodiments, the electronic parking assistance system 12 may not determine the intermediate stopping position or vehicle path until after the vehicle 10 leaves the parking zone. An advantage of these embodiments is that the sensors 13 get a better view of the environment surrounding the parking zone and drive lane and may be able to generate a more compressive set of information that the electronic parking assistance system 12 can use to determine the intermediate stopping position and vehicle path.

In at least some embodiments, the sensors 13 and electronic parking assistance system 12 continue to monitor the environment surrounding the vehicle 10 while the vehicle 10 is being autonomously repositioned. In these embodiments, the electronic parking assistance system 12 can change the location of the intermediate stopping position, add additional intermediate stopping positions, and change the path of the vehicle 10. It may make these changes based on a variety of circumstances including oncoming traffic or the sudden presence of a pedestrian, a third-party vehicle that unexpectedly enters an adjacent parking zone or the drive lane, or any other environmental features or circumstances that are newly detected during the autonomous repositioning process.

In some embodiments, user-defined criterion or parameters are also evaluated and taken into account when determining the intermediate stopping position and the vehicle path. The user-defined criterion may dictate the number of intermediate stopping positions and the vehicle path that are required when autonomously repositioning the vehicle 10 from the first parking position to the second parking position. For example, the user may set a preference for a determined longitudinal orientation of the vehicle 10 (e.g., forward facing or rear facing). If the longitudinal orientation of the vehicle 10 does not need to be reversed to accommodate the user-defined preference, the electronic parking assistance system 12 may determine that the autonomous process needs only a single intermediate stopping position along the vehicle path as the vehicle 10 moves between the first parking position and the second parking position. However, if the user-defined preference requires reversing the longitudinal orientation of the vehicle 10, the electronic parking assistance system 12 may determine that the autonomous process needs two or more intermediate stopping positions along the vehicle path.

In at least some embodiments, an optical or audible warning device associated with the vehicle 10 can be activated by the electronic parking assistance system 12 while the vehicle 10 moves between the first parking position and the second parking position during the autonomous repositioning process. Examples of optical warning devices include lights such as a flashing light or a colored light. Examples of audible devices include alarms, buzzers, and beepers. Additionally, the warning device could be activated either before the vehicle 10 begins to move from the first parking position, before the vehicle 10 exits the parking zone and enters the drive lane, or when the vehicle 10 first enters the drive lane. Activating a warning device can heighten the attention of other people (e.g., drivers and pedestrians) who can then realize that the vehicle 10 is performing an autonomous repositioning process or otherwise moving.

In operation 370, the electronic parking assistance system 12 ends the autonomous process of repositioning the vehicle 10. In at least some embodiments, ending the autonomous process of repositioning the vehicle 10 causes the control system 23 to shut off the vehicle's propulsion system 124, which may include shutting off a traditional engine or terminating the power supply to the system for energizing electric drive motors. In at least some embodiments, it also includes shutting off power to other components in the vehicle 10 that are no longer necessary. In at least some example embodiments, if the electronic parking assistance system 12 determines that the first parking position is suitable and the user does not manually initiate the autonomous repositioning process, operation 370 ends the autonomous process without moving the vehicle 10 from the first parking position. In this situation, the first parking position is also the final parking position.

In at least some embodiments, the autonomous repositioning process will autonomously reposition the vehicle 10 from the first parking position to the second parking position only one time. In alternative embodiments, operation 320 will continue to evaluate the environment surrounding the vehicle 10 even after the vehicle 10 is repositioned into the second parking position. If the electronic parking assistance system 12 determines that a decision criterion is met or the user manually initiates the process of autonomously repositioning the vehicle 10, it will autonomously reposition the vehicle 10 again and repeat operations 350 and 360. An advantage of continuously evaluating the environment surrounding the vehicle 10 and selectively repeating the process of autonomously repositioning the vehicle 10 is that the environment surrounding the vehicle 10 may change making the current position undesirable. For example, another vehicle might park in an adjacent parking zone and be positioned too close to the vehicle 10 thus making reentry into the vehicle 10 difficult or exposing the vehicle 10 to door dings or other damage.

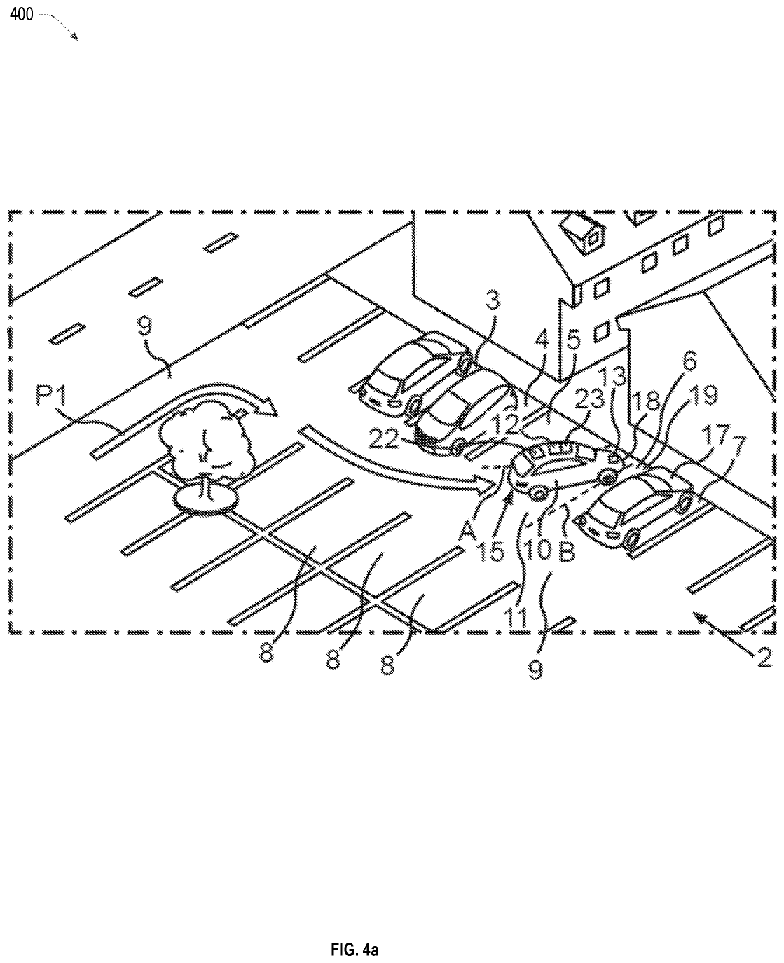

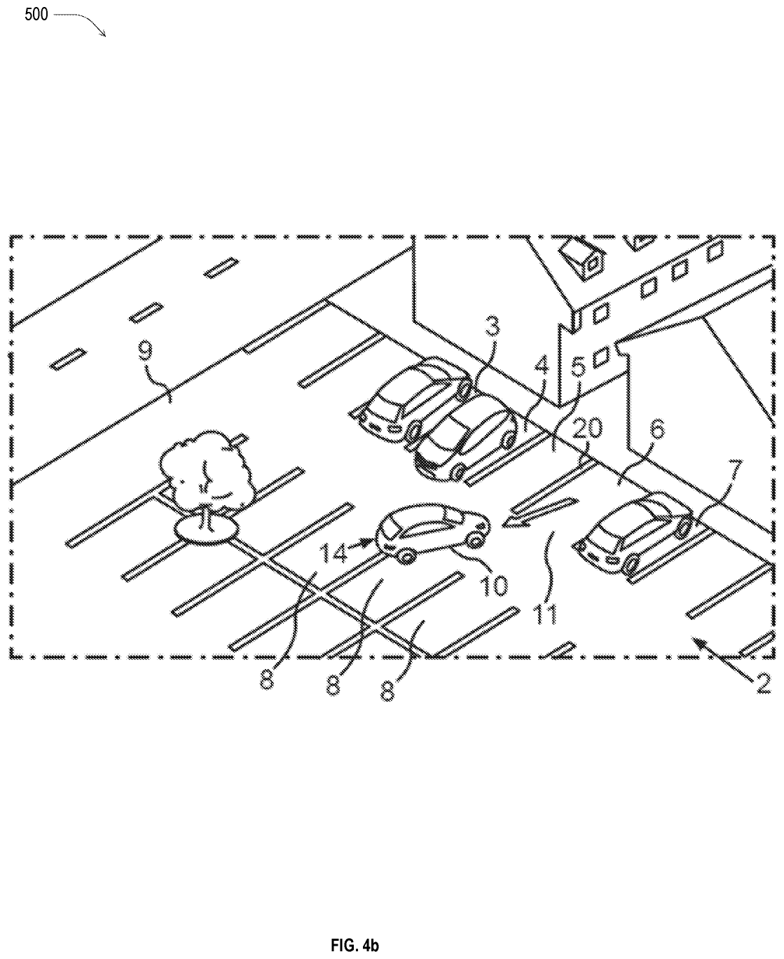

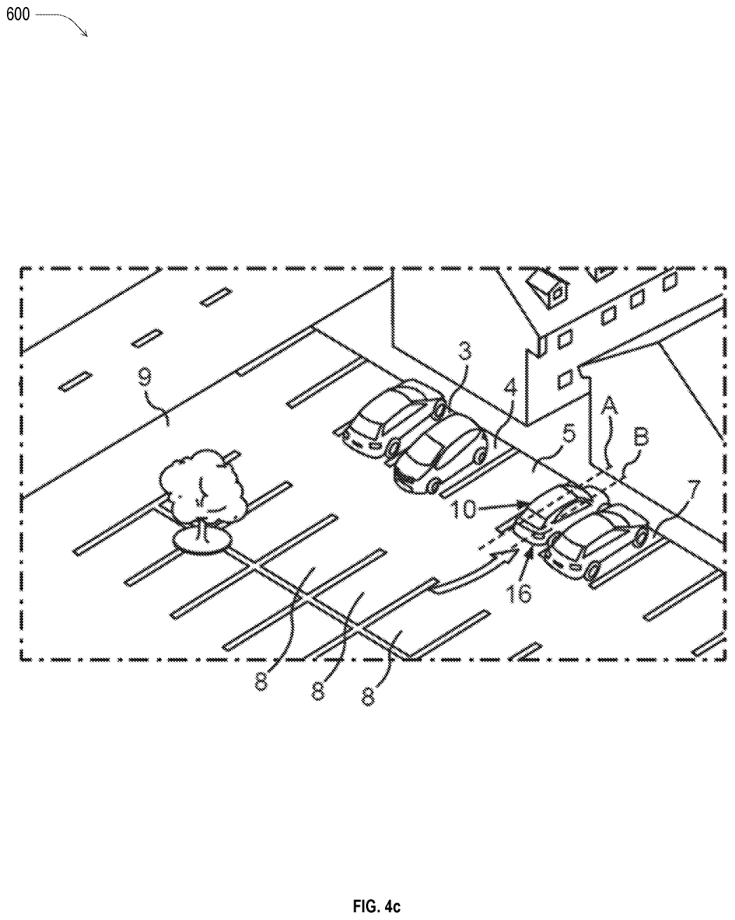

FIGS. 4a-4c illustrate an example scenario in which the vehicle 10 is autonomously repositioned from a first, temporary parking position 15 to a second, final parking position 16.

As illustrated in FIG. 4a, the vehicle 10 is parked in a temporary parking position 15 in a parking zone 6. In at least some embodiments, the vehicle 10 includes a control unit 23 that controls the movement of the vehicle 10 during the autonomous parking process. A parking lot 2 includes a plurality of parking zones 3, 4, 5, 6, and 7 that are marked and identified by defined boundaries such as painted stripes or some other markers. In the illustrated example, there are also open and available parking zones 8. The parking lot 2 also includes a drive lane 9 through which the vehicles can drive to reach the parking zones.

The vehicle 10 moves in the drive lane 9 to the parking zone 6 along the path P1. The vehicle 10 is then parked in a temporary parking position 15. In this example, a driver manually drives the vehicle 10 along the path P1 and into a first parking position 15 in the parking zone 6. The parking position 15 of vehicle 10 does not represent an intended or proper parking position. It is an imprecise temporary parking position 15 and the vehicle 10 is driven into this temporary parking position 15 from the drive lane 9 in a single move or maneuver. In at least some other examples, the vehicle 10 is an autonomous vehicle and is autonomously driven into the temporary parking position 15.

The parking zone 6 is orthogonal to or otherwise transverse to the drive lane 9 and has a parking-zone longitudinal axis B, which is illustrated by a broken line. The vehicle 10 has a vehicle longitudinal axis A. When the vehicle 10 is in the first, temporary parking position 15 as illustrated, the longitudinal axis A is oblique or angled relative to the longitudinal axis B. In the illustrated example, the vehicle 10 is also parked so that the vehicle 10 at least partially protrudes into the adjacent parking zone 5. Additionally, the tailgate of the vehicle 10 extends through an entry 11 of the parking zone 6 and into the drive lane 9.

As discussed in more detail herein, the vehicle 10 includes the electronic parking assistance system 12 and one or more sensors 13 for recording or otherwise detecting features in the environment surrounding the vehicle 10. In example embodiments, one or more of the sensors 13 can detect and record information while the vehicle 10 is driving in the drive lane 9, parking in the first parking position 15, parked motionless in the first parking position 15, or a combination of these situations. Information about the surrounding environmental features can include detected information about obstacles, markers, and other things. The electronic parking assistance system 12 also determines the orientation of the vehicle 10 relative to the parking zone 6. In at least some embodiments, the electronic parking assistance system 12 also determines the orientation of the vehicle 10 relative to the drive lane 9. The detected information also can include information about traffic in the drive lane 9 and nearby pedestrians.

During the repositioning process, as illustrated in FIG. 4b, the vehicle 10 is moved out of the temporary parking position 15 in parking zone 6 to an intermediate position 14. In the illustrated example, the intermediate position 14 is selected such that the vehicle 10 extends at least partially into adjacent parking zones 8 that are across the drive lane 9 from the parking zone 6. Alternatively, the intermediate stopping position 14 could be entirely within a single parking zone 8. In these examples, the electronic parking assistance system 12 determines that the parking zone 8 is unoccupied based on information detected by the sensors 13. The electronic parking assistance system 12 can cause the vehicle 10 to proceed with the autonomous reposition process in a quick and intelligent manner. In the illustrated example, the layout, vehicles, and arrangement of parking zones in the parking lot 2 makes it possible for the vehicle 10 to move from the temporary parking position 15 to the intermediate position 14 in a single maneuver and then from the intermediate position 14 to the final parking position 16 (discussed in more detail herein) also in a single maneuver. If parking zone 8 is occupied at the time of the autonomous process of repositioning the vehicle 10, the electronic parking assistance system 12 will identify a different intermediate stopping position into which the vehicle 10 should be moved during the autonomous process of repositioning the vehicle 10.

As illustrated in FIG. 4c, the vehicle 10 is moved from the intermediate position 14 to the second, final parking position 16 within the parking zone 6. One of the objectives of the electronic parking assistance system 12 is to ensure that a proper and suitable parking position has been achieved with the second, final parking position 16. A suitable parking position can include a parking position in which the longitudinal axis A of the vehicle 10 is parallel or substantially parallel to the longitudinal axis B of the parking zone 6. In at least some example embodiments, the suitable second parking position 16 is also a position in which the longitudinal axis A is substantially coincident with longitudinal axis B.

In yet other example embodiments, a suitable parking position is a parking position in which the vehicle 10 is parked substantially parallel to the longitudinal side boundary 20 of the parking zone 6 without overlapping the boundary 20. For example, a vehicle in adjacent parking zones 5 or 7 might be too close to the boundary 20 with parking zone 6 (e.g., vehicle 17 in parking zone 7). In this scenario, the suitable second parking position 16 might be one in which the longitudinal axis A is offset from the longitudinal axis B.

In at least some example embodiments, the sensors 13 continue to monitor the environment surrounding the vehicle 10 during the autonomous process of repositioning the vehicle 10 and the electronic parking assistance system 12 makes adjustments to the trajectory of the vehicle 10 and adjustments to the anticipated location of the intermediate stopping position 14. For example, another vehicle could pull into the location of a nearby parking zone that the electronic parking assistance system 12 had flagged for the intermediate stopping position 14. In other examples, previously undetected traffic from other vehicles or pedestrians could approach the vehicle 10 in the drive lane 9 or in one of the parking zones.

In FIGS. 4a-4c, the vehicle 10 is illustrated as moving from the first, temporary parking position 15 to the intermediate stopping position 14 in a single maneuver, and from the intermediate stopping position 14 to the second, final position 16 also in a single maneuver. In alternative embodiments, the vehicle 10 will make multiple maneuvers when moving from the first parking position 15 to the intermediate stopping position 14, or multiple maneuvers when moving from the intermediate stopping position 14 to the second parking position 16.

Additionally, FIGS. 4a-4c illustrate the vehicle 10 having the same longitudinal orientation (e.g., the vehicle 10 is parked facing forward) in both the first parking position 15 and the second parking position 16. As discussed in more detail herein, however, the longitudinal orientation of the vehicle 10 can be reversed as it is repositioned from the first parking position 15 to the second parking position 16. For example, the longitudinal orientation of the vehicle 10 can be facing forward when in one of the parking positions (first parking position 15 or second parking position 16). The vehicle 10 can then be backed into the parking zone 6 when in the other parking position (second parking position 16 or first parking position 15) so that it is rear facing. When the vehicle 10 is forward facing, the front portion 18 of the vehicle 10 faces a rear end 19 of the parking zone 6. When the vehicle 10 is backed into the parking zone 6 and rear facing, the front end 18 of the vehicle 10 faces the entry 11 of the parking zone 6 and the drive lane 9.

As explained herein, the longitudinal orientation of the vehicle 10 for the second, final parking position 16 can be set by the user as a user-defined criterion. If the electronic parking assistance system 12 and the vehicle 10 can automatically determine the longitudinal orientation of the vehicle 10, it can automatically begin the autonomous process of repositioning the vehicle 10 from the first parking position 15 to the second parking position 16, including changing the longitudinal orientation of the vehicle 10. In alternative embodiments, the user can manually designate the desired longitudinal orientation of the vehicle 10 upon parking and before the autonomous process of repositioning the vehicle 10 begins. In yet other alternative embodiments, as described in more detail herein, the user can manually initiate the autonomous process of repositioning the vehicle 10 and reverse the longitudinal orientation of the vehicle 10.

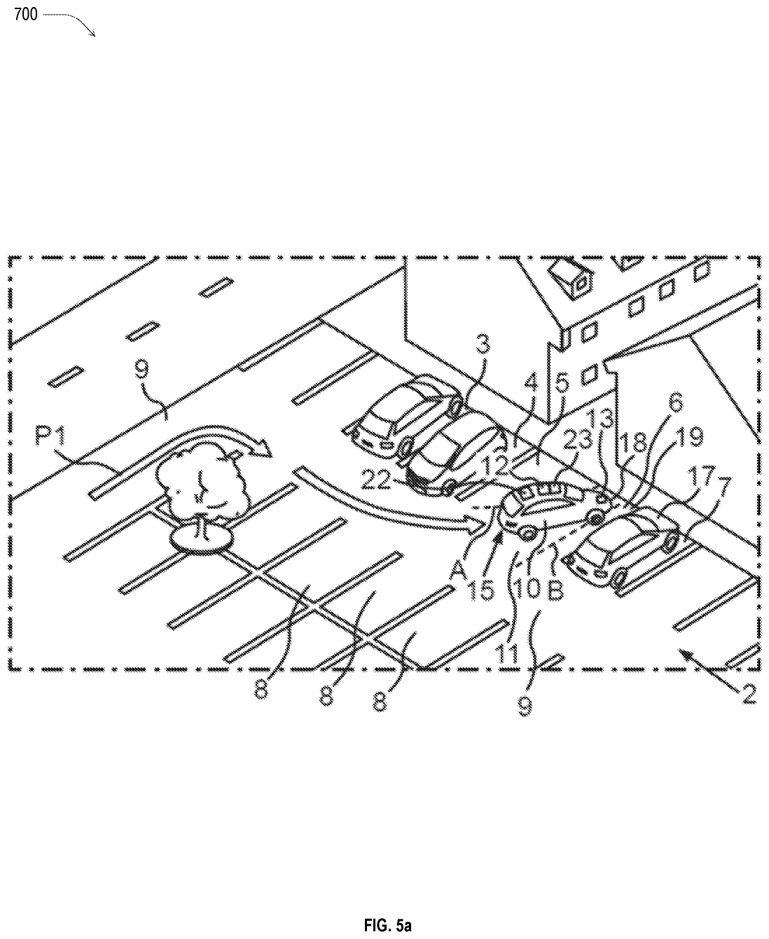

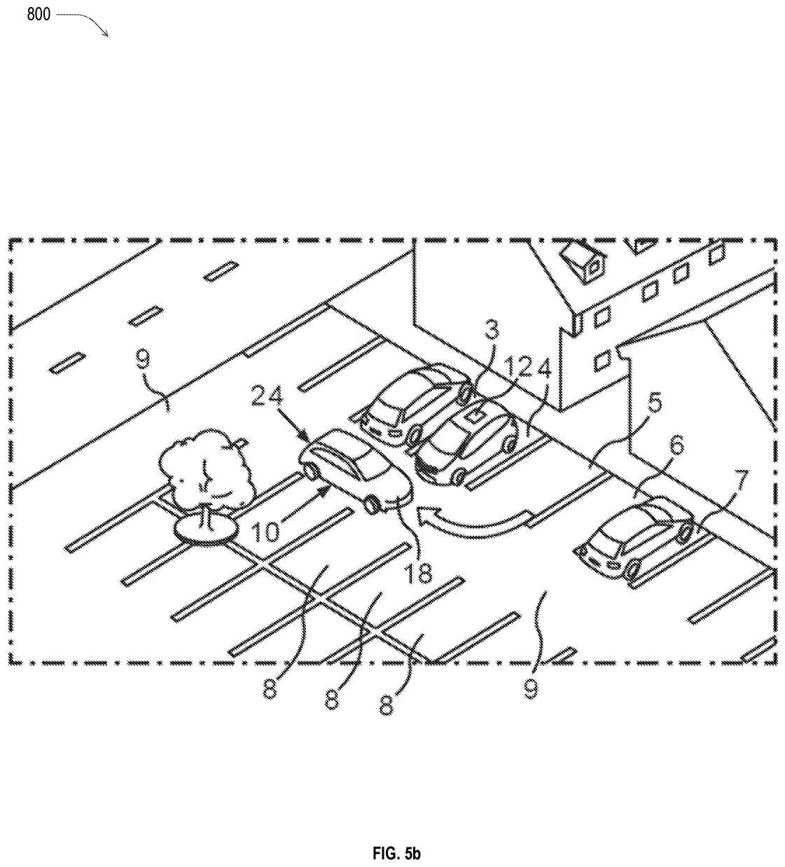

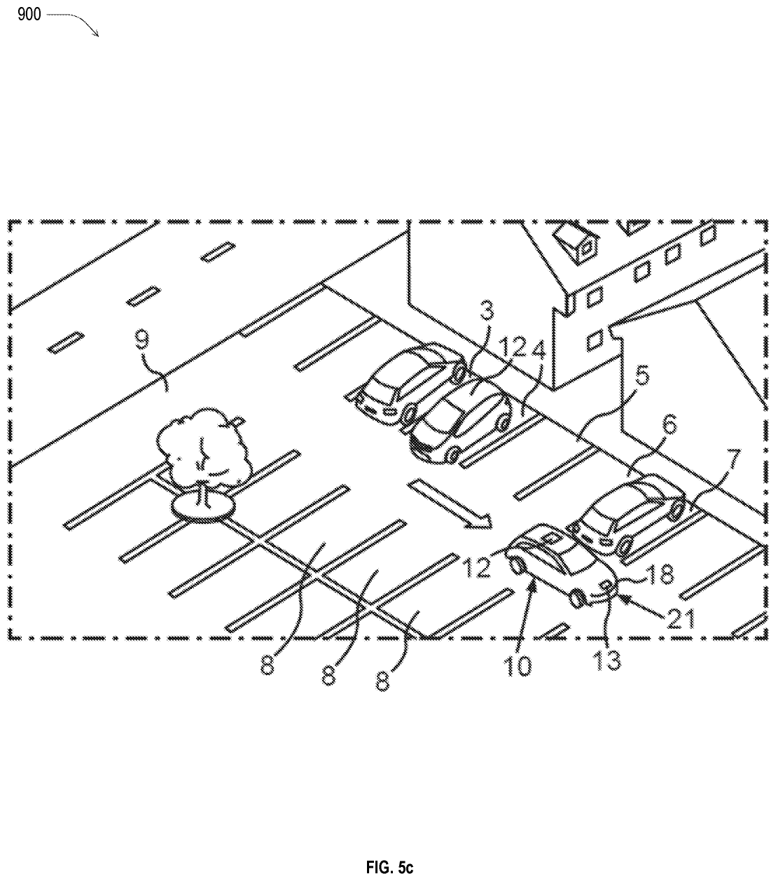

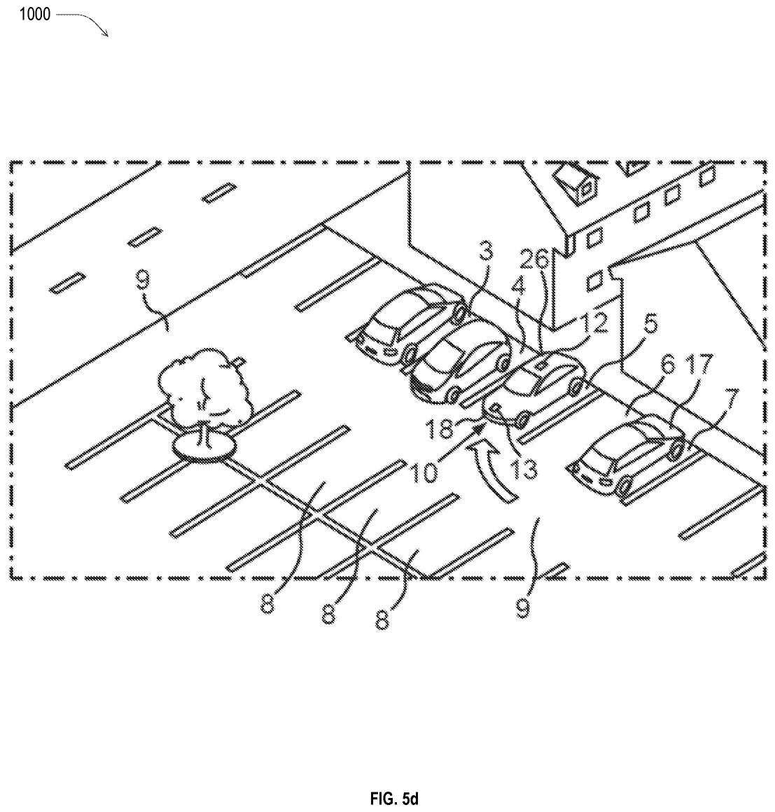

FIGS. 5a-5d illustrate an example of reversing the longitudinal orientation of the vehicle 10 when autonomously repositioning the vehicle 10 from the first parking position 15 to the second parking position 16. Referring to FIG. 5a, the driver manually pulls the vehicle 10 into a first, temporary parking position 15 in parking zone 6. The process of parking in the first parking position 15 is substantially similar to the process of parking illustrated in FIG. 4a. In the example illustrated in FIG. 5a, the vehicle 10 is parked forward facing, although in alternative embodiments the vehicle 10 could be parked rear facing.

Referring to FIG. 5b, the vehicle 10 is moved from the first parking position 15 in parking zone 6 to a first intermediate stopping position 24 in a process similar to the process illustrated in FIG. 4a. In this example, the first intermediate stopping position 24 is entirely within and substantially parallel to the drive lane 9. This positioning allows the vehicle 10 to easily pull forward to a second intermediate stopping position 21 in which it can be backed into the parking zone 6. In alternative embodiments, the first intermediate stopping position 24 is in an open parking zone 8, across the boundary between a combination of adjacent parking zones 8, or across the boundary between the drive lane 9 and one or more parking zones 8. Many other locations for the first intermediate stopping positions 24 are possible.

As illustrated in FIG. 5c, the vehicle 10 is moved from the first intermediate stopping position 24 to a second intermediate stopping position 21. In the illustrated example, the second intermediate stopping position 21 also is entirely within and parallel to the drive lane 9. Additionally, the rear end of the vehicle 10 is positioned so that the vehicle 10 can be backed into the second, final parking position 16 from the second intermediate stopping position 21 in a single maneuver. The second intermediate stopping position 21 can have alternative locations and orientations that are different than the illustrated stopping position. For example, the second intermediate stopping position 21 could be located partially or entirely in one or more parking zones 8 or be orientated at an angle relative to the parking zone 6 or at an angle relative to the drive lane 9.

As illustrated in FIG. 5d, the vehicle 10 is backed into the second, final parking position 16 in parking zone 6 from the second intermediate stopping position 21. In the illustrated example, the vehicle 10 is moved from the second intermediate stopping position 21 to the second parking position 16 in a single maneuver. In alternative embodiments, the process of backing the vehicle 10 into the second parking position 16 from the second intermediate stopping position 21 could be made using two or more maneuvers. Additionally, alternative embodiments could use more than two intermediate stopping positions for maneuvering the vehicle 10.

In the example illustrated in FIGS. 4a-4c, the autonomous secondary parking process is performed with a minimal number of moves, namely two maneuvers. The first maneuver is a reverse maneuver to move the vehicle 10 from the first, temporary position 15 to the intermediate stopping position 14 and a forward maneuver to move the vehicle 10 from the intermediate stopping position 14 to the second, final position 16. In the example illustrated in FIGS. 5a-5d, however, the autonomous process of repositioning the vehicle 10 from a first position 15 to a second position 16 is performed using three maneuvers in order to satisfy the user-defined decision criteria of parking the vehicle 10 backwards when it is in the second, final parking position 16. In alternative embodiments, there could be more than one maneuver for the example illustrated in FIGS. 4a-4c or more than two maneuvers for the example illustrated in FIGS. 5a-5d. The number of maneuvers can be dictated by the layout of the parking lot 2. In other examples, the number of maneuvers can be dictated by environmental features, including traffic. For example, a sensor 13 could detect an approaching vehicle or pedestrian that requires the electronic parking assistance system 12 to recalculate the determined path for moving the vehicle 10.

In some embodiments, when more than one parking zone is unoccupied and available for the electronic parking assistance system 12 to choose from when executing the autonomous process of repositioning the vehicle 10, the electronic parking assistance system 12 will decide which of the unoccupied parking zones 8 in which to park the vehicle 10 in the second, final parking position 16. In the illustrated example shown in FIGS. 4a-4c and 5a-5d, for example, the parking zones 5, 6, and 8 are available to use for the second, final parking position 16. The electronic parking assistance system 12 can decide which parking zone 5, 6, or 8 to use based on a variety of factors. For example, the electronic parking assistance system 12 may choose to use the parking zone 5, 6, or 8 that is closest to a pedestrian pathway if the control unit 23 is programmed with a map and GPS is available. In other examples, the electronic parking assistance system 12 may choose the parking zone 5, 6, or 8 in which the vehicle 10 can be more quickly parked or the parking zone 5, 6, or 8 that will require the fewest number of maneuvers. The electronic parking assistance system 12 also can use other factors to determine which parking zone provides the quickest and most efficient autonomous secondary parking process.

In the example embodiments, the electronic parking assistance system 12 will choose a parking zone for the final parking position 16 that is directly adjacent to or across from the parking zone 6 in which the vehicle 10 is parked in the first parking position 15. In other embodiments, the electronic parking assistance system 12 will choose a parking zone that is separated from the original parking zone 6 by only a few parking zones. If the parking zone for the vehicle 10 is changed during the autonomous repositioning process, it would be undesirable for the vehicle 10 to be parked in a distant parking zone because it could cause the user confusion because it may make it difficult for the user to locate the repositioned vehicle 10. Therefore, limiting the electronic parking assistance system 12 to choose only parking zones that are directly adjacent to, or at least nearby, the original parking zone reduces the possibility that the user will be unable to locate the vehicle 10 upon returning.

Additionally, the systems and methods are disclosed herein with respect to perpendicular or angle parking. In at least some possible embodiments, however, they can be used for parallel parking. For example, the vehicle 10 could quickly pull nose first into a parallel parking zone and be positioned at an angle relative to the curb or other boundary of the parking zone. The autonomous process of repositioning the vehicle 10 could then reposition the vehicle 10 from this first parking position to a second parking position in which the vehicle 10 is parked parallel to the curb defining a boundary of the parallel parking zone.

The various embodiments described above are provided by way of illustration only and should not be construed to limit the scope of the claims attached hereto. Those skilled in the art will readily recognize various modifications and changes that may be made without following the example embodiments and applications illustrated and described herein, and without departing from the true spirit and scope of the following claims. It is intended that any such modifications and equivalents be included in the scope of the claims.

What is claimed is:

1. A method for parking a vehicle in a parking zone designed as a marked parking spot, in which the vehicle is driven on a path outside the parking zone to the parking zone and is subsequently parked autonomously in the parking zone, the method comprising:
driving the vehicle to the parking zone with a driver present in the vehicle;
parking in a temporary parking position in the parking zone, wherein, after reaching the temporary parking position, the driver vacates the vehicle;
performing an autonomous process of repositioning the vehicle from the temporary parking position to a final parking position on the basis of at least one decision criterion; and
positioning the vehicle in the final parking position in a parking zone by the autonomous parking process.

2. The method of claim 1, wherein the temporary parking position is reached by a manual guiding of the vehicle by the driver.

3. The method of claim 1, wherein the temporary parking position is reached by moving the vehicle in one move into the parking zone from outside the parking zone.

4. The method of claim 1, wherein the autonomous process of repositioning the vehicle from the temporary parking position to the final parking position is initiated by the driver.

5. The method of claim 4, wherein initiating the autonomous parking process includes specifying whether to park the vehicle front facing or rear facing in the final parking position in the parking zone.

6. The method of claim 1, further comprising:
automatically determining, using an autonomous parking assistance system, whether to perform the autonomous parking process on the basis of traffic in the drive lane and adjacent to the parking zone, the traffic being at least one current traffic situation, at least one future traffic situation, or a combination thereof;
wherein the determining is performed regardless of whether the driver is still next to the vehicle after having vacated the vehicle.

7. The method of claim 6, further comprising:
determining a starting position for the vehicle for performing the autonomous process of repositioning the vehicle in the parking zone is determined by the parking assistance system;
autonomously moving the vehicle out of the parking zone from the temporary parking position to the intermediate stopping position; and
after reaching the intermediate stopping position, autonomously moving the vehicle from the intermediate stopping position to the final parking position in the parking zone.

8. The method of claim 7, further comprising:
determining the autonomous process for repositioning the vehicle using the parking assistance system on the basis of information including at least one of: an orientation of the vehicle in the temporary parking position, a determined orientation of the vehicle in the final parking position as specified by a user, environmental features detected in the environment proximal to the vehicle, or combinations thereof.

9. The method of claim 8, wherein the information is generated from the output of at least one sensor.

10. The method of claim 9, wherein the information is generated from the output of at least two sensors, at least one of the sensors being a different type of sensor than at least another of the sensors.

11. The method of claim 8, wherein during the autonomous process of repositioning the vehicle, the vehicle exits the parking zone completely and into the intermediate stopping position, and is then maneuvered from the intermediate stopping position into the parking zone until the vehicle reaches the final parking position.

12. The method of claim 11, further comprising:
automatically locking the vehicle after the driver has vacated the vehicle and the driver is a determined distance from the vehicle, regardless of whether the vehicle is in the temporary parking position, is moving during the autonomous process of repositioning the vehicle, or is in the final parking position.

13. The method of claim 1, further comprising:
activating a warning device when performing the autonomous process of repositioning the vehicle, the warning device being operably connected to the vehicle.

14. A method of autonomously repositioning a vehicle in an individual parking spot, the method comprising:
manually driving the vehicle into a first parking position and parking the vehicle;
detecting at least one feature in an environment surrounding the vehicle;
determining at least one intermediate stopping position and a path of travel for the vehicle, the at least one intermediate stopping position being along the path; and
autonomously moving the vehicle from the first parking position, to the intermediate stopping position, and then to a second parking position, the vehicle traveling along the path of travel.

15. The method of claim 14, wherein the first parking position is at least partially in a parking zone and the second parking position is in the same parking zone.

16. The method of claim 15, wherein the intermediate stopping position is completely outside of the parking zone and at least partially in a drive lane adjacent to the parking zone.

17. The method of claim 14, wherein the first parking position and the second parking position are in different parking zones.

18. The method of claim 14, wherein the act of autonomously moving the vehicle is performed if determined decision criterion are met, the determined decision criterion including: whether a portion of the vehicle when in the first parking position is protruding into an adjacent parking zone, whether a portion of the vehicle when in the first parking position is protruding into a drive lane, whether a portion of the vehicle when in the first parking position is within a determined distance of an adjacent parking zone, whether the longitudinal axis of the vehicle when in the first parking position is parallel to a longitudinal axis of the parking spot, whether the longitudinal axis of the vehicle when in the first parking position is offset from the longitudinal axis of the parking spot by a determined amount, a longitudinal orientation of the vehicle when in the first parking position, user-defined parameters, and combinations thereof.

19. The method of claim 18, wherein the act of autonomously moving the vehicle is automatically initiated upon determining at least one of the decision criterion is met.

20. The method of claim 18, wherein the act of autonomously moving the vehicle begins upon manual initiation by a user.

21. The method of claim 14, wherein the vehicle has a longitudinal orientation when in the first parking position and an opposite longitudinal orientation when in the second parking position.

22. The method of claim 21, wherein the act of autonomously moving the vehicle includes moving the vehicle to two or more intermediate stopping positions as the vehicle moves along the path.

23. The method of claim 14, wherein the act of detecting at least one feature in an environment surrounding the vehicle has an occurrence selected from the group consisting essentially of: before the vehicle enters the first parking position, while the vehicle enters the first parking position, while the vehicle is parked in the first parking position, while the vehicle exits the first parking position, as the vehicle travels along the path, and combinations thereof.

24. The method of claim 23, wherein the act of detecting at least one feature in an environment surrounding the vehicle is repeated as the vehicle travels along the path.

25. The method of claim 23, wherein the act of determining at least one intermediate stopping position and a path of travel for the vehicle has an occurrence selected from the group consisting essentially of: before the vehicle enters the first parking position, while the vehicle enters the first parking position, while the vehicle is parked in the first parking position, while the vehicle exits the first parking position, as the vehicle travels along the path, and combinations thereof.

26. The method of claim 25, wherein the act of determining at least one intermediate stopping position and a path of travel for the vehicle is repeated as the vehicle travels along the path.

27. A vehicle capable of autonomously repositioning from a first parking position to a second parking position, the vehicle comprising:
wheels;
a steering gear operably connected to at least one of the wheels;
a propulsion system operably connected to at least one of the wheels;
at least one sensor arranged to detect a feature in an environment surrounding the vehicle, the at least one sensor configured to output a sensor signal related to the feature; and
a control system in data communication with the at least one sensor, the control system having memory storing executable program instructions and sensor data related to the sensor signal, and a programmable circuit programmed to process the sensor data, detect the presence of at least one feature in an environment surrounding the vehicle based at least in part on the sensor data, determine at least one intermediate stopping position and a path of travel for the vehicle based at least in part on the sensor data, the at least one intermediate stopping position being along the path, control the steering gear and the propulsion system to autonomously move the vehicle from the first parking position to the intermediate stopping position and then to the second parking position, the vehicle traveling along the path of travel.

28. The vehicle of claim 27, further comprising:
two or more sensors arranged to detect a feature in an environment surrounding the vehicle, each of the two or more sensors configured to output a sensor signal related to the feature; and
the programmable circuit programmed to process sensor data related to the sensor output from each of the two or more sensors and detect the presence of at least one feature in an environment surrounding the vehicle based at least in part on the sensor data output from each of the two or more sensors.

29. The vehicle of claim 28, wherein at least one of the sensors is a camera, the output of the sensor is sensor data defining an image, and the programmable circuit is programmed to execute image recognition software to detect the presence of the at least one feature.

30. The vehicle of claim 29, wherein the camera is a charge-coupled device.

31. The vehicle of claim 27, wherein the memory stores user-defined parameters and the programmable circuit is programmed to determine the second parking position at least in part on the user-defined parameters.

32. The vehicle of claim 31, wherein the vehicle further comprises:
a user interface, the user interface configured to receive the user-defined preferences from a user and then input the received user-defined preference into the control system.
